(19) United States
(12) Patent Application Publication
(10) Pub. No.: US 2016/0034838 A1
(43) Pub. Date: Feb. 4, 2016

(54) ENHANCED OPERATIONAL RESILIENCY SCORING USING INTELLIGENCE INDICATORS

(71) Applicant: Mark GEMBICKI, Pasadena, MD (US)

(72) Inventor: Mark Gembicki, Pasadena, MD (US)

(21) Appl. No.: 14/777,126

(22) PCT Filed: Mar. 17, 2014
(86) PCT No.: PCT/US14/30371

§ 371 Date: Sep. 15, 2015

Related U.S. Application Data
(60) Provisional application No. 61/798,152, filed on Mar. 15, 2013.

(51) Int. Cl. G06Q 10/06; G06N 5/04; G06N 99/00

(52) U.S. Cl. CPC G06Q 10/06393; G06N 99/005; G06N 5/046

(57) ABSTRACT

Disclosed herein are systems, methods, and non-transitory computer-readable storage media for describing the resiliency of an organization by obtaining resiliency intelligence, determining confidence in the intelligence, generating resiliency scores, bundling scores into multiple level of granularity, and providing score bundles to users based on a membership level.

### CROSS REFERENCE TO RELATED APPLICATIONS

This application is claims priority to and the benefit of U.S. provisional patent application Ser. No. 61/798,152, filed Mar. 15, 2013 and entitled “Systems and Methods for Measuring the Resiliency of Organizations” which is incorporated by reference herein in its entirety.

### BACKGROUND

1. Technical Field

The present disclosure relates to generally to systems and methods for measuring the resiliency of organizations. More particularly, this application relates to systems and methods for providing a resilience score describing the resiliency of organizations.

2. Introduction

Business and government enterprises that are able to quickly adapt to or seize competitive advantage from sudden and/or significant changes in their environments, with minimal interruption to their enterprise missions and manageable impact to their market value, can be described as resilient. An organization's resilience, properly understood, has critical implications for its competitive posture, profitability and shareholder value. Leading management and information technology consultancies share this belief.

Over the past several years, business, academic and government leaders have become aware that certain organizations respond better to disruptions than other, often similarly situated, organizations. For example, in a September 2003 Harvard Business Review article entitled, “The Quest for Resilience,” Gary Hamel and Liisa Valikangis stated that momentum is not the force it once was in ensuring an organization's success. They noted the emergence of several disruptive trends—including technological discontinuities, regulatory upheavals, geopolitical shocks, industry deverticalization and disintermediation, abrupt shifts in consumer tastes, and hordes of nontraditional competitors—that require companies to become resilient to remain successful. The authors concluded that strategic resilience is not about responding to a one-time crisis or about rebounding from a setback. Rather, the authors posited that strategic resilience involved continuously anticipating and adjusting to deep, secular trends that can permanently impair the earning power of a core business and about having the capacity to change before the case for change becomes desperately obvious.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for scoring the resiliency of an organization.

Some embodiments of the present technology involve a resiliency scoring system receiving, from an individual client or strategic partner, a request for one or more resiliency scores for an organization.

The resiliency scoring system can obtain intelligence for the organization relating to a plurality of base resiliency indicators that are chosen by examining the request, determining an industry type described in the request by comparing the request to a resiliency index, selecting an industry specific resilience core data store, and extracting, from the industry specific resilience core data store, the plurality of resiliency indicators.

Obtaining intelligence can also involve examining a resilience core data store containing a collection of resiliency indicators that are factors in a set of predefined essential elements of information relating to the request for one or more organizational resiliency score.

Based on the obtained intelligence, the resiliency scoring system can generate base scores for each of the plurality of base resiliency indicators using a scoring model comprising a compilation of market data, market information, and market intelligence describing companies and government agencies based on the plurality of resiliency indicators.

Resiliency scores can be used to determine an organization's own resiliency, research or compare your organization to, among others, competitive interests, supply chains, investment portfolios, market ecosystems or geographic regions, etc.

The base scores can be compiled to assemble multiple levels of scores, each one of the multiple levels of scores providing scores corresponding to resiliency indicators corresponding to the one of the multiple levels of scores, the granularity of the resiliency indicators being reduced for each lower one of the multiple levels of scores.

In some embodiments, level three scores can include scores for each resiliency indicator, level two scores can include a plurality of sub-group scores describing an aggregation of level three scores using a geometric means calculation, and a level one score can comprise an aggregation of level two sub-group scores using a geometric means calculation.

In some cases, the plurality of sub-group scores can include ten primary factors of resiliency including: Operational Risk scores; Management scores, Disaster Management scores, Legal/Regulatory Compliance scores, Financial Stability scores, PR/Media Management scores, Ecosystem scores, Corporate Strategy scores, Supply Chain/Procurement scores, Information Security scores, and Human Capital scores.

In some embodiments, the resiliency scoring system can determine one or more levels of scores available to the user based on a membership level for the user. For example, the resiliency scoring system can provide a user with a first membership level a single level one score, can provide a user with a second membership level multiple level one scores and charging a fee to the user with the second membership level for each level one score requested by the user with the second membership level, and can provide a user with a third membership level a plurality of level two scores along with narrative information from the set of predefined essential elements of information.

In some embodiments of the present technology, the resiliency scoring system can also generate a confidence score for one or more of the base scores. The confidence rating can be a product of a function of the relevance of the intelligence, the reliability of the intelligence, and the currency of the intelligence. Base scores can also be compared to a qualitative knowledge database and adjusted using rules described in the qualitative knowledge database. Likewise, base scores can be weighted by system operators or users based on their subject evaluation of the importance of the base scores in determining resiliency.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system including a resiliency score platform for generating resiliency scores and presenting the resiliency scores to a plurality of strategic partners and individual clients;

FIG. 2 illustrates an exemplary method of showing resiliency scores to a partner or client according to some embodiments of the present technology;

FIG. 3 illustrates a diagram showing an exemplary organization of industry types for use with a resiliency index according to some embodiments of the present technology;

FIG. 4 illustrates an exemplary sample of cross-industry resiliency scores;

FIG. 5A illustrates an exemplary interface element showing a resiliency analytics comparison for a banking and finance market schema;

FIG. 5B illustrates an exemplary interface element showing a report containing a list of resiliency scores for selected companies in the banking and finance industry; and

FIG. 6A and FIG. 6B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for objective descriptions of organizational resiliency. Resilience can be a measure of an organization's capacity to anticipate disruptions, adapt to events and create lasting value. A system, method and non-transitory computer-readable media are disclosed which describe the resiliency of an organization by obtaining resiliency intelligence, determining confidence in the intelligence, generating resiliency scores, bundling scores into multiple level of granularity, and providing score bundles to users based on a membership level.

In some embodiments of the present technology, an objective description of organizational resiliency is derived from digital information sources using a big data approach that utilizes a Resilience Core Data Store comprised of a collection of resiliency indicators that are factors in a set of predefined essential elements of information (“EEIs”) which are themselves factors in one or more business essential query (“BEQ”).

The Resilience Core Data Store can be used to collect intelligence relating to organizational resilience by collecting publically available information relating to the resiliency indicators, determining that the gathered intelligence affects one or more aspect of an organization's resiliency, calculating a confidence score for the gathered information, aggregating collected intelligence that affects one or more aspect of an organization's resiliency, and generating one or more resiliency score for the organization.

The resiliency scores can be derived from publicly available data and other information sources that enable organization personnel to identify and mitigate weaknesses in their organizational resilience, both in absolute terms and relative to their competitors or ecosystem. This unique cross-industry performance metric presents a level of actionable intelligence to decision-makers in the organization that are timely, relevant and accurate.

Some embodiments of the present technology involve systems, methods and computer-readable medium for converting publicly available data into actionable intelligence (including measuring the resiliency of an organization) using an exemplary five-step, cyclical process involving:

Requirements Definition: Framing the BEQs or other questions to be answered against a collection of resiliency key performance indicators (“KPIs”) and confirm with automated and human resources;

Collection Management: Deciding the manner in which the structured, semi-structured and unstructured data will be organized and archived.

Source Validation & Discovery: Identify sources of information and apply a confidence scoring algorithm that measures relevancy, reliability, and currency of the collected intelligence;

Multi-source Fusion: Processing normative and transitory data derived from multiple sources using an analytical framework into a collection of grades for KPIs and employing a cueing mechanism that monitors for redundancies and ambiguities, as well as new sources and KPI improvements; and

Actionable Presentation: Cataloging, formatting, securing and delivering the compilation of actionable intelligence.

Resiliency scores can be used to determine an organization's own resiliency, research or compare your organization to, among others, competitive interests, supply chains, investment portfolios, market ecosystems or geographic regions, etc. Resiliency scores can be determined by both qualitative and quantitative approaches, as explained herein.

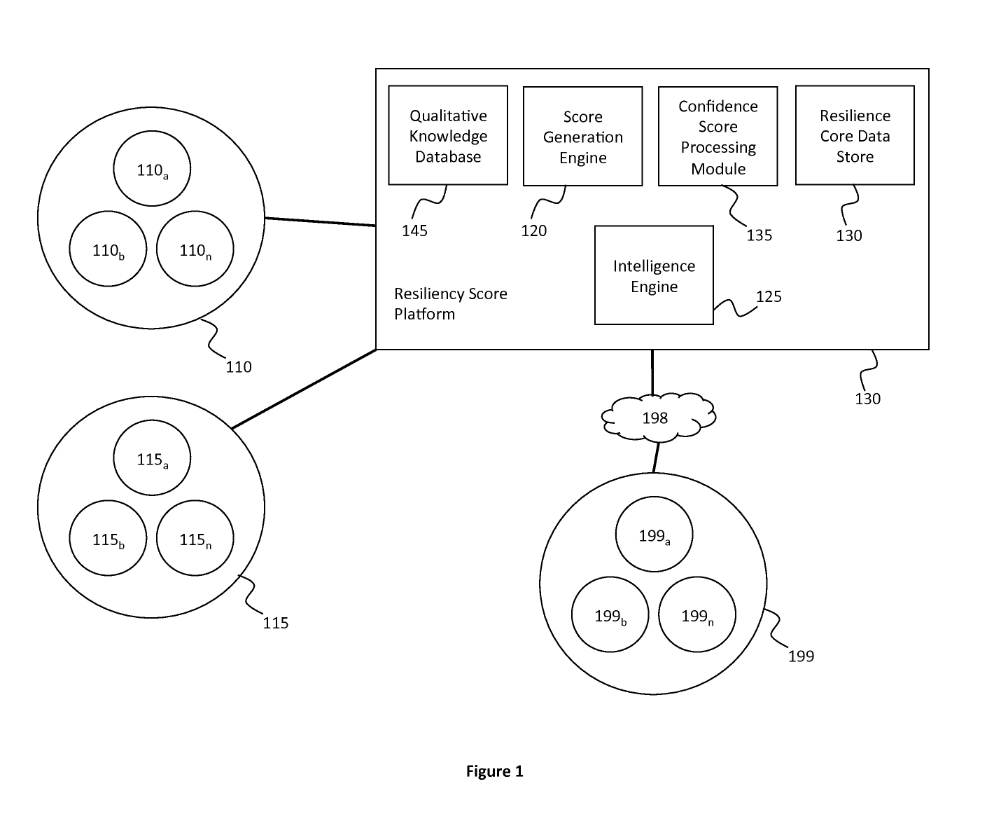

FIG. 1 illustrates an exemplary system 100 including a resiliency score platform 105 for generating resiliency scores and presenting the resiliency scores to a plurality of strategic partners 110 (110a, 110b, . . . , 110n) and individual clients 115 (115a, 115b, . . . , 115n). The resiliency score platform 105 comprises a resiliency score generation engine 120 operatively coupled with an intelligence engine 125. The intelligence engine 125 can be configured to request information from a plurality of information sources 199 (199a, 199b, . . . , 199n) via a network 198. The intelligence engine 125 is operably coupled with a Resilience Core Data Store 130. In some embodiments of the present technology, the Resilience Core Data Store 130 is an extensible data structure containing a structured collection of resiliency indicators that are factors in a set of predefined essential elements of information (“EEIs”) which are themselves factors in one or more business essential query (“BEQ”). The intelligence engine 125 is configured to interpret BEQs, EEIs, and request information relevant to the resiliency indicators from the plurality of information sources 199a, 199b, . . . , 199n. The intelligence engine 125 is also operatively coupled with a confidence scoring processing module 135; and, once information relevant to the resiliency indicators is received, the intelligence engine 125 requests that the confidence scoring processing module 135 quantify the information with a confidence score (explained in greater detail below).

In some embodiments of the present technology, the intelligence engine 125 is also operatively coupled with a qualitative knowledge database 140 containing learned rules for grading organizational resiliency—the rules learned by humans, computers, or both.

In some embodiments, the intelligence engine draws intelligence from publicly available material, including: the Internet, traditional mass media (e.g. television, radio, newspapers, magazines), specialized journals, conference proceedings, think tank studies, conference presentations, public share sites for professional content, photos and videos, geospatial information (e.g. maps and commercial imagery products), etc.

The resiliency score generation engine 120 is configured to gather intelligence (e.g. raw intelligence, information quantified with a confidence score, information along with learned rules, and combinations thereof) from the intelligence engine 125 and assign a score to a plurality of resiliency key performance indicators for a strategic partner 110 or individual client 115. Approaches to scoring are explained in greater detail below.

The resiliency score generation engine 120 can aggregate the scores and provide an organization a resiliency score describing an overall resiliency of the organization. The resiliency score generation engine 120 can also combine subsets of resiliency key performance indicators into more generalized groups. Likewise, the resiliency generation engine 120 can assign scores to the more generalized groups.

In some embodiments of the present technology, each factor in a set of ten primary factors (“10 Dimensions of Resilience,” as explained below) affecting an aspect of an organization's resiliency can receive a score describing how well the organization performs with respect to each factor. Each individual resiliency key performance indicator can also be inter-related in more than one primary factor.

Each of the ten primary factors can also be broken down into a more granular group of sub-factors that more specifically describe a particular aspect of resiliency. In some embodiments, the sub-factors can be broken down further until the actual resiliency key performance indicators are exposed and shown to correlate with an aspect of the organization's resiliency.

The resiliency score generation engine 120 is further configured to present score data to strategic partners 110 and individual clients 115. The kind and amount of score data provided to partners and clients can depend on a membership level that the partner or client has with the resiliency score platform (membership levels are explained in greater detail below.) For example, an individual client 110a with free membership can only access the overall resiliency score for a single organization while a strategic partner 115a with a premium membership can view the score for each of the 10 Dimensions of Resilience along with a narrative (extracted from the Resilience Core Data Structure) describing what behaviors or organizational qualities lead to the score being what it is. However, the present technology is not limited to two levels of membership. Rather, any number of levels of membership and the amount of access to the levels of scores can also vary.

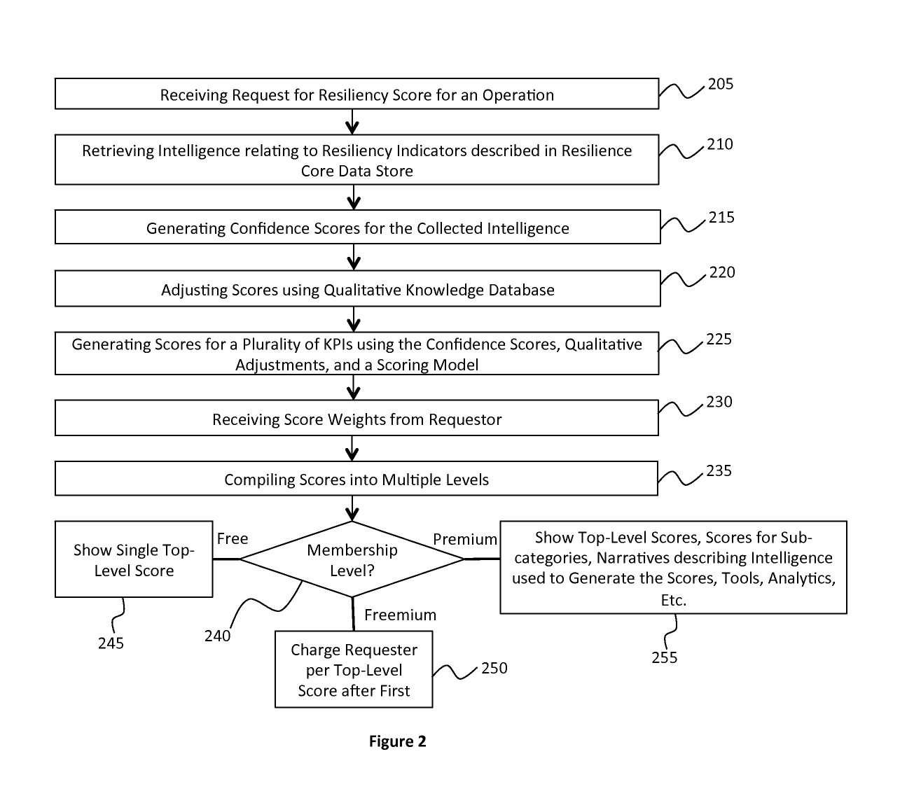

FIG. 2 illustrates an exemplary method 200 of showing resiliency scores to a partner or client according to some embodiments of the present technology. The method 200 involves receiving a request for one or more resiliency scores for an operation from requestor at step 205, such as a request from strategic partners 110 or individuals clients 115. In response to such a request, the method 200 proceeds to step 210, where intelligence is retrieved relating to resiliency indicators described in a resilience core data store. As noted above this can involve intelligence engine 125 accessing information sources 199 to obtain market data, market information, and market intelligence describing companies and government agencies, as needed. In some embodiments, retrieving intelligence involves the preclusion of private or confidential information. This practice can help the system achieve objectivity because its scores will be based solely on publicly available data and information.

Next, the method 200 involves generating confidence scores for the intelligence collected at step 215. Confidence scores (Z Confidence Score) can serve as a quality control mechanism for the collection and analysis of intelligence and open source information. A high confidence score enables clients and preferred partners to rapidly and accurately assess incoming data to make more effective decisions. This approach allows for the direct comparison of gathered intelligence/information over a distribution since it is based on a common statistical Z-score for standardizing data. The basic elements of a confidence score are relevancy, reliability and currency.

Equation (1) describes an exemplary algorithm for generating a confidence score for standard information gathered by an intelligence engine to analyze resilience according to some embodiments of the present technology.

Z Confidence Score=ZRV³+ZRL²/Z Currency=Confidence (standardized) Equation (1)

(1a) Intelligence Source Relevancy=RV1+RV2, where:
RV1=Degree to which the information answers the BEQ on a 0 to 4 scale; and
RV2=Depth and detail of the information on a 0 to 4 scale.

(1b) Intelligence Source Reliability=RL1+RL2, where:
RL1=Level of confidence in the source as determined by previous accuracy; and
RL2=Source's position to be in-the-know on a 0 to 4 scale.

(1c) Intelligence Source Currency=C1+C2³, where:
C1=Timeliness measured in hours, where 1 to 12 hours receives a “1” rating, 13 to 24 hours receives a “2”, and so on in 12 hour increments; and
C2=Ability of the information to impact the market, competitors, etc. in the current time frame, the contemporary nature of the information, on a 4 to 0 scale, where 4 is the least efficacious in the contemporary.

(1d) Z Score=x+mean/Standard Deviation.

Equation (2) describes an exemplary algorithm for generating a confidence score for business information gathered by an intelligence engine to analyze resilience according to some embodiments of the present technology.

Z Confidence Score=ZRV3+ZRL2/Z Currency=Confidence (standardized) Equation (2)

(1a) Intelligence Source Relevancy=RV1+RV2, where:
RV1=Degree to which the information answers the BEQ on a 0 to 4 scale; and
RV2=Depth and detail of the information on a 0 to 4 scale.

(1b) Intelligence Source Reliability=RL1+RL2, where:
RL1=Level of confidence in the source as determined by previous accuracy; and
RL2=Source's position to be in-the-know on a 0 to 4 scale.

(1c) Intelligence Source Currency=C1, where:
C1=Timeliness measured in hours, where 1 to 12 hours receives a “1” rating, 13 to 24 hours receives a “2”, and so on in 12 hour increments; and

(1d) Z Score=x+mean/Standard Deviation.

Returning again to FIG. 2, once the confidence scores are obtained at step 215, the method 200 involves adjusting the scores using a qualitative knowledge database at step 220. Thereafter, the generating of scores for a plurality of resiliency key performance indicators using the confidence scores, the qualitative adjustments, and a scoring model can be performed at step 225. The scoring model can be designed to assign scores using a cross-industry, cross-functional resilience index. The resilience index can comprise a market-based compilation of data, information, and intelligence on global companies and government agencies based on resiliency key performance indicators.

In some embodiments, the method 200 can involve, at step 230, receiving weighting information from the requestor specifying how to weight one or more scores in relation to others. In some embodiments, the ability for a requestor to weight scores is only given to requestors who have an enhanced membership level, explained below.

The method 200 also involves compiling scores at step 235 into multiple levels of granularity. For example, the method 200 can involve scoring each resiliency key performance indicator separately, scoring a group of resiliency key performance indicators (combined based on their respective relevance to a particular sub-category of overall resilience), and scoring an overall combination of all the sub-categories of resilience. In some embodiments, the scores given to individual resiliency key performance indicators, sub-categories of resilience, etc. are combined using a geometric means calculation.

Although the present disclosure at times explicitly describes the use of a geometric means calculation for combining or aggregating scores, the various embodiments are not limited in this regard. Rather, any other methods for generating a combined score from multiple sub-scores, including weighted methods, can be used with the present technology. For example, a score can be computed using an arithmetic mean, a geometric mean, a harmonic mean, a quadratic mean, a generalized mean, a weighted mean, or a truncated mean, to name a few.

In addition, confidence score calculations can be performed for the scores at each of the multiple levels in substantially a same manner as described above with respect to step 215.

As mentioned above, the present technology can involve a plurality of membership tiers. The membership tiers can be based on usage (e.g., member charged for a usage amount) or the tiers can be subscription based (e.g., annual subscription premium members receive unlimited content and unlimited usage).

Also, in some configurations, the system can employ a “freemium” model that publishes aggregate top-level resiliency scores at no charge to anyone who desires to view them. To obtain more detailed information to mid-level scores and to access additional information, analytics, etc., users will be required to pay a monthly subscription fee.

Referring back to FIG. 2, the method 200 can further involve determining a requestor's membership level at step 240. In the event that the member has a “Free” membership, the method 200 involves showing the requestor the single, top-level resilience score at step 245. In the event that the member has a “Freemium” type membership, the method 200 involves charging the requestor per top-level resilience score that he views at step 250. Also, in the event that the member has a “Premium” membership, the method 200 involves showing unlimited score information at step 255. This can involve, for example, displaying various amounts of information, including top-level scores, scores for sub-categories of resilience, narratives describing the intelligence used to generate the scores, tools for interacting with the scores, analytics for analyzing the scores, to name a few. As noted above, there can also be additional levels of scores and additional membership levels controlling the amount the access to scores and related information.

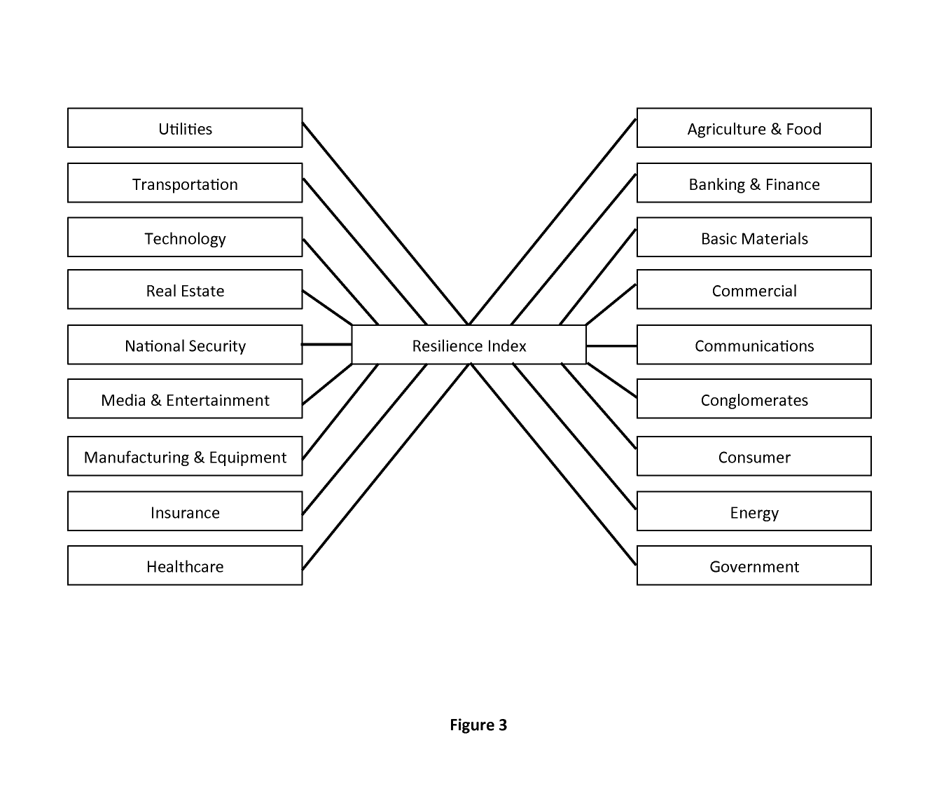

As explained above, in some embodiments, the process for measuring resiliency can include a scoring model. This scoring model can be designed to position an organization for benchmarking and performance improvement management using a sophisticated cross-industry and cross-functional resilient index. FIG. 3 illustrates a diagram 300 showing an exemplary organization of industry types for use with a resiliency index according to some embodiments of the present technology. The resiliency index can provide information about a plurality of industry types. For example:

Utilities: Distribution Facilities, Independent Power Producers, Public Service Infrastructure Maintenance, Electricity, Multiline, Natural Gas, Water & Steam;

Transportation: Aerospace, Airlines & Airport Services, Freight & Courier Services; Logistics, Marine Port Services, Motor Vehicle & Parts, Packaging & Containers, Passenger Transportation, Railroads, Trucking;

Technology: Communications Equipment, Computer Hardware, Electrical Equipment, Electronics, Internet Providers & Applications, IT services & Consulting, Office Equipment, Scientific, Photographic & Control Equipment, Semiconductors, Equipment & Testing, Software;

Real Estate: Commercial, Development & Operations, Residential, Services;

National Security: Critical Infrastructure Resilience, Defense Industrial Base, Emergency Services, Intelligence Community, Nuclear & Advanced Energy, Research & Development;

Media & Entertainment: Advertising & Marketing, Broadcasting, Entertainment Production, Diversified Media, Information Services, Publishing & Printing, Social Media, Video Games;

Manufacturing & Equipment: Aerospace Products & Parts, Agricultural, Electrical Components & Equipment, Engineering & Construction, Heavy Electrical Equipment, Industrial Machinery, Motor Vehicles, Primary Metal, Railroad Rolling Stock, Trading & Distribution;

Insurance: Brokers, Casualty, Health, Life, Multiline, Property, Re-insurance;

Healthcare: Biotechnology, Facilities, Managed Care, Medical Equipment, Medical Research, Supplies & Distribution, Pharmaceuticals, Pharmacy, Services, Public Health;

Agricultural & Food: Beverages, Fishing & Farming, Food Distribution & Convenience Stores, Food Processing, Food Services, Tobacco;

Banking & Finance: Banks, Commercial, Credit, Savings & Loans, Universal, Consumer Services, Diversified Financial & Investment Services, Financial & Commodity Market Operators, Financial Data Services, Investment Banking & Brokerage, Investment Management & Fund Operators, Investment Trusts, Real Estate Investment Trusts;

Basic Materials: Aluminum, Chemicals, Construction, Forest & Wood, Paper Products, Precious Metals & Minerals, Mining & Metals, Steel;

Commercial: Business Support Services, Diversified Outsourcing, Employment Services, Environmental Services, Printing;

Communications: Delivery Infrastructure, Telecommunications Services, Integrated Wireless, Voice, Video & Data Services;

Conglomerates: Africa, Asia, Europe, Latin America, North America, Oceania, Intercontinental;

Consumer: Apparel & Accessories, Automobiles, Services & Parts, Casinos & Gaming, Diversified Retail, Footwear, Homebuilding & Construction Supplies, Hotels & Cruise Lines, Household Goods, Leisure & Recreation Products, Personal Products, Personal Services, Restaurants, Specialty Retailers, Textiles & Leather Goods;

Energy: Delivery Infrastructure, Distribution, Coal, Equipment Manufacturing & Installation, Exploration, Oil & Gas, Refining & Marketing, Renewable Energy; and

Government: Federal/National, Regional, State, Local, Territorial; Tribal, Public Sector Services.

The foregoing are but a few examples. In the various embodiments, other industry types can be considered as well.

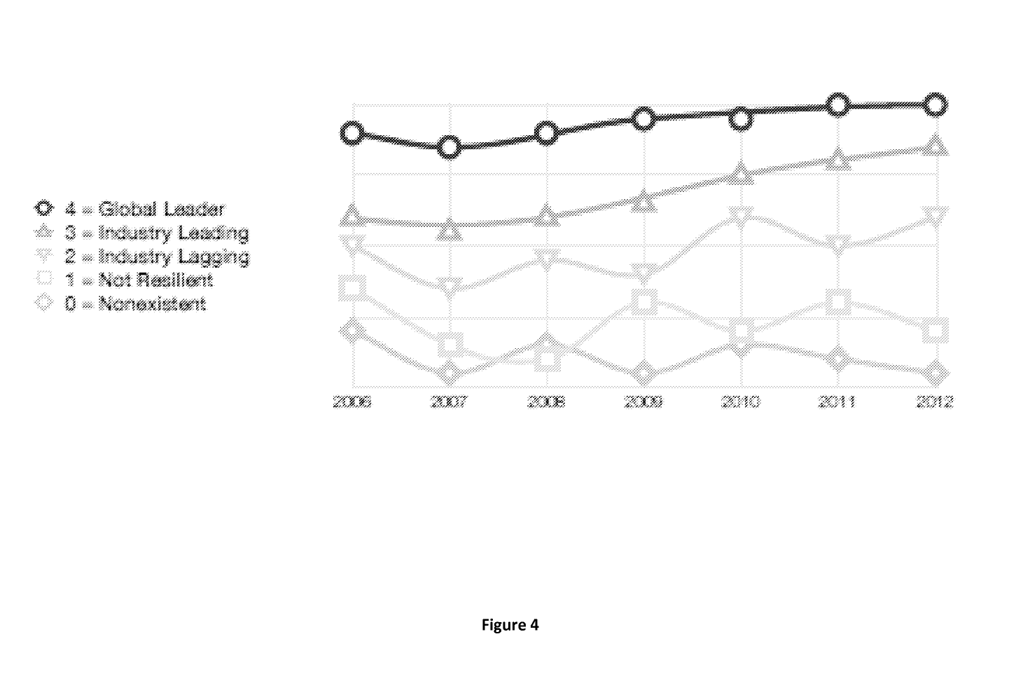

A resiliency score can also be derived from this index by measuring any organization against standard resiliency key performance indicators which are expressed as “factual conditions,” the extent to which a specific criteria is satisfied on a scale from 0 to 4, where 4 denotes the highest resiliency and 0 denoting failure. FIG. 4 is plot 400 illustrating an exemplary sample of cross-industry resiliency scores ranging from a Global Leader 4 to a Nonexistent 0.

In FIG. 4, a majority of organizations scored from 0 to 1 typically remain in this range and experience rapid ascents and descents in a resilient rating. Those scored from 1 to 2 achieve greater leaps in resilience since many of the organization's core functions are beginning to unify around the resilience framework. The jump from a 2 to 3 is the most challenging and rewarding since it fosters the need for a concentrated change management approach from market lagging to market leading. World-class organizations that are rated in the 3 to 4 range are more predictable in performance and offer premium value to their ecosystems and stakeholders.

As explained above, the scoring model can be used to generate resiliency scores and the resilience index can be used to effectively measure or gauge the resiliency scores. The resilience index leverages consulting services to drive high-value, objectively measurable and sustainable resiliency solutions. The resilience index provides market-based measures to indicate an organization's performance capabilities and characteristics in the areas that are important contributors to their being resilient. The output of resilience index can be tailored and focused on resiliency measures of an organization. From the index, the resiliency score can be calculated and measured which provides an overall performance index.

To measure an organization's resiliency, these processes objectively measure and manage the data collected. In some processes, measuring levels of resiliency can be a matter of identifying the key indicators of resiliency, including: Operational Risk Management, Disaster Management, Legal/Regulatory Compliance, Financial Stability, PR/Media Management, Ecosystem, Corporate Strategy, Supply Chain/Procurement, Information Security, and Human Capital.

Using resiliency scores, a user can assess the organization's score, analyze its level of resiliency, measures its compliance of legal and regulatory factors mandated for example by the government, conduct training and awareness sessions to educate the executives of fortune 1000 companies, create a resiliency architecture, etc.

Some embodiments of the present technology involve tools and analytics used to interact with resiliency information generated by the resiliency score platform.

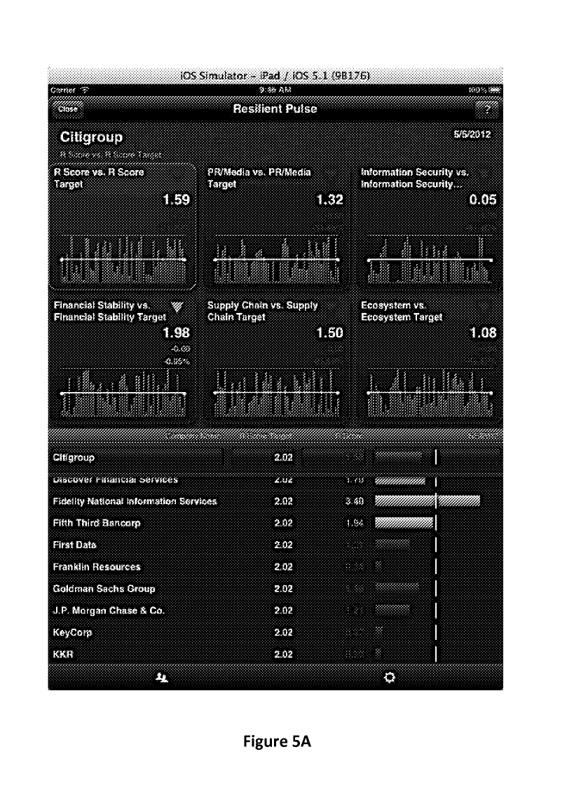

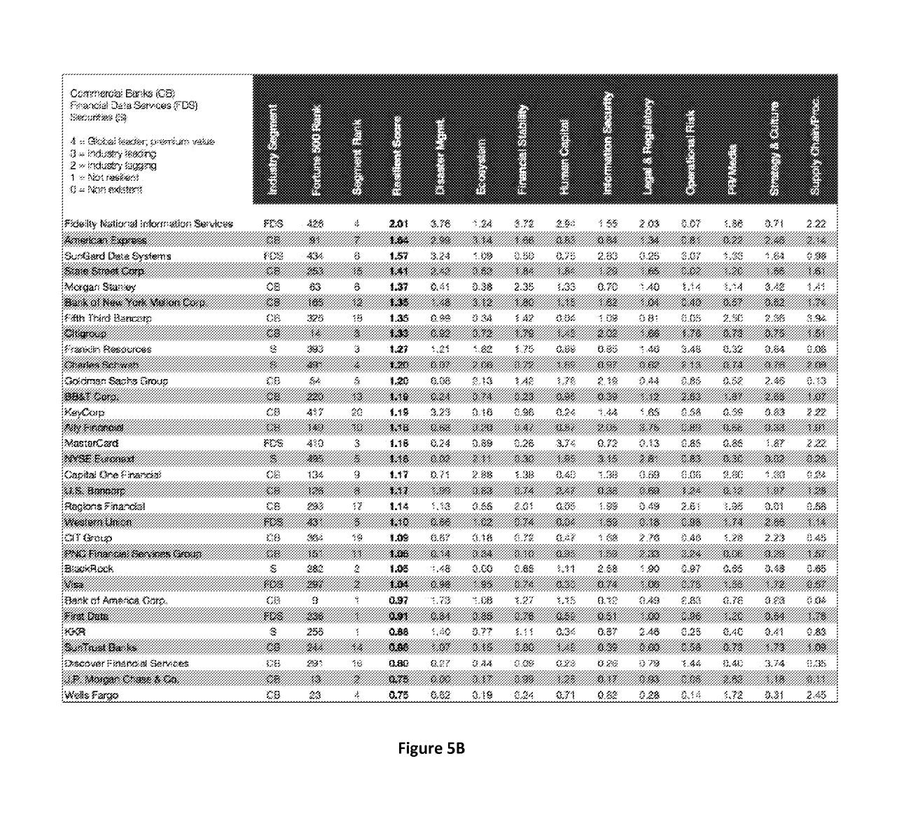

As an example, FIG. 5A contains a screenshot of a Resilient Analytics comparison for the Banking & Finance market schema. The performance of institutions is presented in an interactive, drill-down environment to compare resiliency scores and/or factors (e.g. Ecosystem, Financial Stability, Information Security, Public Relations and Media, and Supply Chain.) to target values. As shown in FIG. 5A, the resiliency scores and/or factors can be compared to target values instantly or as a function of time. Accordingly, the resiliency scores and/or factors can be tracked and monitored in a similar fashion as traders might track stock prices or other conventional economics indicators.

The tools and analytics of the present technology allow customers to improve their competitive position and shareholder value by capturing a wide view of any business or government landscape. This view consists of resilience assessments for global corporations and government agencies across a wide variety of industries and public sectors.

Each organization can be measured against hundreds of resilient key performance indicators as a standalone entity and as part of its industry, geography, ecosystem, etc. The update frequency can involve a refresh occurring regularly and or reactively using a complex set of public event alert mechanisms (i.e., news flow, weather, financial indicators, etc.).

Some embodiments of the present technology involve tools for analyzing the data, provides detailed scoring, interactive dashboards, predictive modeling and in-depth reporting tools.

In some configurations, the technology involves using a resiliency wheel which demonstrates a snapshot of the organization's resiliency status and where it stands compared to its industry competitors. Likewise, in some cases, resilience information can be displayed on an automated dashboard based on its findings. This dashboard can demonstrate the organization's level of resiliency for primary resiliency indicators and it can be used to drill down to sub-groups and even provide the resiliency score for individual indicators.

In some embodiments, the technology is well suited for any circumstance in which the degree of resiliency of an organization meets the desire or needs to become more resilient than its current state. In particular, it is most useful for organizations where a man-made or natural disaster could devastate the operability of that organization and could have a large affect on the community including the impact on the shareholder value.

The benefits of the system include but are not limited to: empowered situational awareness, improved decision-making, cost savings and optimized spending, potential positive insurance coverage impacts, converts security from cost to investment, supports evolving national direction from the Department of Homeland Security, supports emerging guidance from the U.S. Securities and Exchange Commission

The present technology allows the system to rapidly collect, assess, measure and score an organization's level of readiness and resiliency. The users are assured of a reputable source of knowledge behind the resiliency score that is relevant, reliable and current.

Thus, the various embodiments can be utilized to generate information for comparing the resiliency of various organizations for a wide range of factors. For example, an exemplary report containing a list of R-Scores and factors for selected companies in the Banking & Finance industry as of Sep. 5, 2011 is provided in FIG. 5B. A partial scope analysis was conducted using a substantial subset of the relevant resilient key performance indicators. Note that the average score is 1.17—Not Resilient. In comparison, however, the performance average for all 18 industries and public sectors in the United States then was 2.38—Industry Lagging. The highest rated organization scored a 2.01 and ranked as number 426 on the Fortune 500 list. The lowest rated companies were grouped at 0.75, yet ranked as numbers 13 and 23 on the Fortune 500 list.

Part of the resilience score can include governance. Governance can play an important role in creating sustainable and valuable organizations. It represents a common business language to proactively balance risk and opportunity against organizational goals and objectives in any competitive environment. To maximize the use of good governance, some embodiments of the present technology involve an assured resileince process to remediate, improve and manage resilience scores and ratings. This systematic approach can allow subscribers and their supply chain vendors reach desired levels or resilience through a series of successful, predictable outcomes—the strategic principle of Operational Resilience.

One example of a component of the resilient index is the resilience key performance indicators for Information Security. This component is an important measurement of an organization's ability to detect, stop or deter, and audit cyber attacks—ranging from digital to blended physical attack vectors. However, it can weighted higher for the Banking & Finance industry since it is a critical infrastructure to any nation's stability and economic well-being. In a period of market instability, such as alerts to the increased levels of cyber attacks, each industry would be elevated automatically. In this scenario, organizations that have nonexistent, poor or lagging information security programs would receive a lower resilience score while those with industry leading or world class resilience score would benefit since their enterprises are designed to deflect attacks.

In some embodiments, the systems and processes described herein can be used to historically rank organizations with a resilience score. The implications of not being resilient are reflected in the following historical examples of name-brand companies suffering major disruptions as defined by the resilience key performance indicator for Supply Chain & Procurement:

A chemical company suffered an $11 million profit loss because a worker accidentally tripped a shutoff switch at a major Ontario plastics plant, stopping production and causing two weeks of repairs, which resulted in unfilled contracts.2

A chemical company negotiated a $16.5 million settlement with the Environmental Protection Agency based on their failure to report information about the health and environmental risks of a substance used in the manufacturing process.

A drug company's lack of a well-documented supply chain for medicines is a problem that has come under the spotlight with multiple deaths and some 350 allergic reactions among patients.

A toy company experienced a share price drop from a high of $29.34 to $20.97, after the announcement that its supply chain failed to detect lead paint in its toys, dramatically affecting earnings. Mattel was later fined $2.3 million by the Consumer Product Safety Commission.

The financial impact of supply chain and procurement disruptions is significant and often sustained, as evidenced by the seminal research of Kevin Hendricks, Professor of Operations and Information Technology in the School of Business and Economics at Wilfrid Laurier University, and Vinod Singhal, DuPree College of Management at Georgia Institute of Technology. Their analysis on the volatility changes associated with three types of supply chain risks includes: increases of 5.40 percent for production disruptions; 10.48 percent for excess inventory; and 10.23 percent for product introduction delays. Moreover, it was discovered that when a supply chain disruption or malfunction was announced, stock prices plunge on an average of 8.62 percent, and shareholder wealth decreased by $120 million or more per company on the day of the announcement. During a three-year span, regardless of industry, disruption cause or time period, affected companies experienced 33-40 percent lower stock returns relative to their industry peers. Likewise, share price volatility in the year after the disruption was 13.5 percent higher when compared with the volatility in the year before the disruption.

The present technology accounts for these definitive risks in its resilience key performance indicators to help manage the profound effect on operational metrics, working capital, and strategic (shareholder/stakeholder) value.

The present technology can also be used to conduct back-testing and demonstrate that results that stocks of resilient enterprises outperform the broader market indices over time. For example, back tests on limited data sets reveal that a portfolio of companies selected on externally observable criteria for resilience match or outperform the S&P 500 over one-, three- and five-year periods. Other examples include the Supply Chain & Procurement R-Scores for FedEx and Target which are consistently market leading while Apple has improved its score for Financial Stability, PR & Media, and Strategy & Culture R-Scores from market leading to world-class.

Given the detailed research, analysis, and back-testing used to create the index, there exist many scenarios in which the scoring can be used. Some examples include:
Companies that wish to protect shareholder value as well as identify strategic partners or acquisitions targets and obtain other competitive advantages from being resilient;
Investment funds, investment banks, commercial banks, and law firms and groups that manage capital, advise companies in connection with mergers, acquisitions and otherwise manage risk and capital on a principal basis or as an advisor;
Insurance providers interested in underwriting new forms of risk mitigations for people, processes, technologies, and infrastructures and using resilience-based actuarial models;
Government agencies and public sector organizations with oversight responsibilities for commerce, public markets, national security, public health, safety, and competitiveness;
Marketing and public relations firms, think tanks, industry associations, foundations and other enterprises involved in advocacy or thought leadership.

The resilience index and resilience scores can also help organizations build a resilient mindset and complementary set of capabilities will be rewarded for their efforts relative to their peers—both by shareholders/stakeholders.

Since disruptions affect share prices negatively by introducing volatility into earnings streams, resilient enterprises can demonstrate less earnings volatility and should get higher values from investors.

The present technology can also add value to any organization being analyzed. By expertly mining and filtering high value intelligence and open source information against dynamic resilience key performance indicators, the system can provide organizations with a quantity and quality of actionable intelligence unmatched in the industry. The open source channels also serve as a cueing mechanism to accurately focus intelligence collection for proactive positioning and reactive event detection.

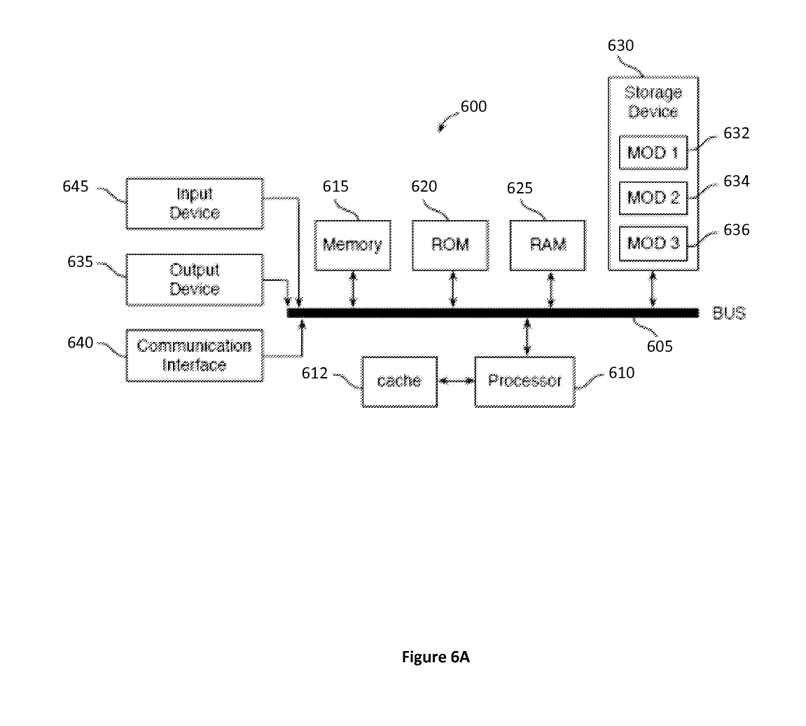

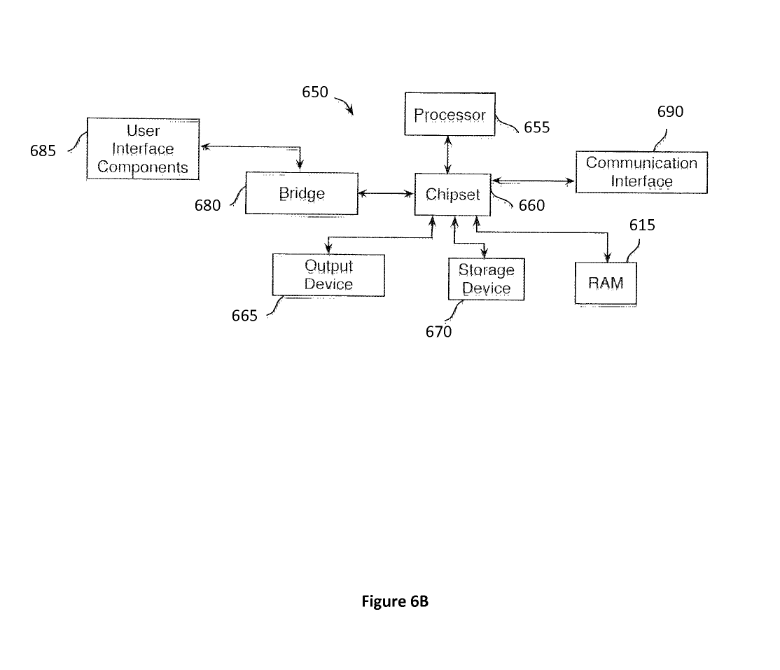

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method, comprising:
receiving a request for one or more resiliency scores for an organization from a user device associated with a user;
obtaining intelligence for the organization relating to a plurality of base resiliency indicators;
based on the intelligence, generating base scores for each of the plurality of base resiliency indicators using a scoring model;
compiling the base scores to assemble multiple levels of scores, each one of the multiple levels of scores providing scores corresponding to resiliency indicators corresponding to the one of the multiple levels of scores, the granularity of the resiliency indicators being reduced for each lower one of the multiple levels of scores;
determining one or more of the multiple levels of scores available to the user based on a membership level for the user; and
providing the one or more of the multiple levels of scores to the user device.

2. The computer-implemented method of claim 1, wherein the plurality of resiliency indicators are chosen by:
examining the request;
determining an industry type described in the request by comparing the request to a resiliency index;
selecting an industry specific resilience core data store; and
extracting, from the industry specific resilience core data store, the plurality of resiliency indicators.

3. The computer-implemented method of claim 1, wherein the scoring model comprises a compilation of market data, market information, and market intelligence describing companies and government agencies based on the plurality of base resiliency indicators.

4. The computer-implemented method of claim 1, wherein the multiple levels of scores comprise:
level three scores comprising scores for each resiliency indicator;
level two scores comprising a plurality of sub-group scores describing an aggregation of level one scores using a geometric means calculation; and
a level one score comprising an aggregation of level two sub-group scores using a geometric means calculation.

5. The computer-implemented method of claim 4, wherein plurality of sub-group scores comprise: Operational Risk scores; Management scores, Disaster Management scores, Legal/Regulatory Compliance scores, Financial Stability scores, PR/Media Management scores, Ecosystem scores, Corporate Strategy scores, Supply Chain/Procurement scores, Information Security scores, and Human Capital scores.

6. The computer-implemented method of claim 1, wherein obtaining intelligence relating to a plurality of resiliency indicators further comprises examining a resilience core data store containing a collection of resiliency indicators that are factors in a set of predefined essential elements of information relating to the request for one or more organizational resiliency score.

7. The computer-implemented method of claim 6, wherein providing the scores at the selected level of score granularity comprises:
providing a user with a first membership level a single level one score;
providing a user with a second membership level multiple level one scores and charging a fee to the user with the second membership level for each level one score requested by the user with the second membership level; and
providing a user with a third membership level a plurality of level two scores along with narrative information from the set of predefined essential elements of information.

8. The computer-implemented method of claim 1, further comprising:
generating a confidence score for one or more of the base scores, the confident rating comprising the product of a function of the relevance of the intelligence, the reliability of the intelligence, and the currency of the intelligence.

9. The computer-implemented method of claim 8, wherein the function comprises:
defining a RV1 variable defining a degree to which the intelligence answers a query for information on a 0 to 4 scale;
defining an RV2 variable defining a depth and detail metric of the intelligence on a 0 to 4 scale;
defining an RL1 variable describing a level of confidence in the source as determined by an accuracy value from a previous scoring event;
defining an RL2 variable describing a qualitative metric relating to the intelligence source's position to be in-the-know on a 0 to 4 scale;
defining a C1 variable describing timeliness of the intelligence, where recent intelligence receives a low value and old intelligence receives a high value;
defining a C2 variable describing a qualitative metric relating to an ability of the information to impact other organizations, on a 4 to 0 scale, where 4 is the least impactful.

10. The computer-implemented method of claim 9, wherein the confidence scores equal:
[(RV1+RV2)³+(RL1+RL2)²]/[C1+C2³].

11. The computer-implemented method of claim 1, further comprising:
comparing the scores to a qualitative knowledge database; and
adjusting the scores using rules the qualitative knowledge database.

12. The computer-implemented method of claim 11, wherein the rules in the qualitative knowledge database are machine-learned rules.

13. The computer-implemented method of claim 1, wherein generating base scores for each of the plurality of base resiliency indicators further includes one or more weights from the user for increasing the importance of one or more indicator.

14. A computer-implemented method of calculating a confidence score for information automatically collected from a network resource comprising:
defining a RV1 variable defining a degree to which the intelligence answers a query for information on a 0 to 4 scale;
defining an RV2 variable defining a depth and detail metric of the intelligence on a 0 to 4 scale;
defining an RL1 variable describing a level of confidence in the source as determined by an accuracy value from a previous scoring event;
defining an RL2 variable describing a qualitative metric relating to the intelligence source's position to be in-the-know on a 0 to 4 scale;
defining a C1 variable describing timeliness of the intelligence, where recent intelligence receives a low value and old intelligence receives a high value;
defining a C2 variable describing a qualitative metric relating to an ability of the information to impact other organizations, on a 4 to 0 scale, where 4 is the least impactful; and
generating a confidence scores equal to [(RV1+RV2)³+[RL1+RL2)²]/[C1+C2³]

15. A system comprising:
a network interface configured to receive a request for one or more resiliency scores for an organization from a user device associated with a user;
an intelligence gathering processing engine configured to obtain intelligence for the organization relating to a plurality of base resiliency indicators;
a score generation processing engine configured to:
generate, based on the intelligence, base scores for each of the plurality of base resiliency indicators using a scoring model comprising a compilation of market data, market information, and market intelligence describing companies and government agencies based on the plurality of resiliency indicators;
compile the base scores to assemble multiple levels of scores, each one of the multiple levels of scores providing scores corresponding to resiliency indicators corresponding to the one of the multiple levels of scores, the granularity of the resiliency indicators being reduced for each lower one of the multiple levels of scores;
determine one or more of the multiple levels of scores available to the user based on a membership level for the user; and
provide the one or more of the multiple levels of scores to the user device via the network interface.

16. The system of claim 15, wherein the intelligence gathering processing engine is further configured to examine a resilience core data store containing a collection of resiliency indicators that are factors in a set of predefined essential elements of information relating to the request for one or more organizational resiliency score.

17. The system of claim 16, wherein the score generation processing engine is further configured to:
provide a user with a first membership level a single level one score;
provide a user with a second membership level multiple level one scores and charging a fee to the user with the second membership level for each level one score requested by the user with the second membership level; and
provide a user with a third membership level a plurality of level two scores along with narrative information from the set of predefined essential elements of information.

18. A non-transitory computer-readable storage medium comprising:
a medium configured to store computer-readable instructions thereon; and
the computer-readable instructions that, when executed by a processing device cause the processing device to perform a method, comprising:
receiving a request for one or more resiliency scores for an organization from a user device associated with a user;
obtaining intelligence for the organization relating to a plurality of base resiliency indicators;
based on the intelligence, generating base scores for each of the plurality of base resiliency indicators using a scoring model comprising a compilation of market data, market information, and market intelligence describing companies and government agencies based on the plurality of resiliency indicators;
compiling the base scores to assemble multiple levels of scores, each one of the multiple levels of scores providing scores corresponding to resiliency indicators corresponding to the one of the multiple levels of scores, the granularity of the resiliency indicators being reduced for each higher one of the multiple levels of scores;
determining one or more of the multiple levels of scores available to the user based on a membership level for the user; and
providing the one or more of the multiple levels of scores to the user device.

19. The non-transitory computer-readable storage medium of claim 18, wherein obtaining intelligence relating to a plurality of resiliency indicators further comprises examining a resilience core data store containing a collection of resiliency indicators that are factors in a set of predefined essential elements of information relating to the request for one or more organizational resiliency score.

20. The non-transitory computer-readable storage medium of claim 19, wherein providing the scores at the selected level of score granularity comprises:
providing a user with a first membership level a single level one score;
providing a user with a second membership level multiple level one scores and charging a fee to the user with the second membership level for each level one score requested by the user with the second membership level; and
providing a user with a third membership level a plurality of level two scores along with narrative information from the set of predefined essential elements of information.
